(19) United States
(12) Patent Application Publication
(10) Pub. No.: US 2013/0125908 A1
(43) Pub. Date: May 23, 2013

(54) METHOD OF MANUFACTURING PLASTIC NAILS AND PLASTIC NAILS MANUFACTURED THEREBY

(71) Applicant: Chi Hwan JEONG, Bucheon-si (KR)

(72) Inventor: Chi Hwan JEONG, Bucheon-si (KR)

(21) Appl. No.: 13/303,183

(22) Filed: Nov. 23, 2011

(51) Int. Cl. A45D 31/00; B29C 45/16; B29D 99/00

(52) U.S. Cl. 132/73; 264/132

(57) ABSTRACT

The present invention relates to a method of manufacturing plastic nails having a structure preventing parts, transferred patterns, or UV coating layers of plastic nails from falling off by the impact in daily life of a user. The method of manufacturing plastic nails comprises printing at least one pattern on a film belonging to the fore-end of the plastic nail, forming the film on which the above-mentioned pattern is printed in the shape of the fore-end of the plastic nail which is curved, cutting the film formed in the shape of the fore-end to make film members, inserting the above-mentioned film members inside the cavities of the injection mold, and forming main bodies of the plastic nails at the same time of integrating the film members with the main bodies of the plastic nails by injecting synthetic resin into the above-mentioned injection mold and hardening the same.

### BACKGROUND OF THE INVENTION

1. Field of the Invention

The present invention relates to a method of manufacturing plastic nails and plastic nails manufactured thereby, and more particularly, a method of manufacturing plastic nails having a structure preventing a printed portion and a coated layer of a plastic nail from falling off by the impact in daily life of a user after having put on plastic nails and plastic nails manufactured thereby.

2. Description of Related Art

The plastic nail is an accessory improving beauty of nails by being attached on an real nail and the same may be manufactured in the shape of a nail by the injection molding. Various patterns may be printed on the surface of plastic nails and users may use a product of a desired design.

Since the users may easily put on plastic nails on the surfaces of their real nails by means of adhesive, the users can make their nails look long without letting their natural nails grow long, may easily replace them, and may give the nails various and fancy look according to the users' liking. In addition, since the plastic nails can easily be maintained, they are widely used.

The conventional plastic nails are manufactured by printing various patterns on the injection product formed of synthetic resin. The plastic nails manufactured by such a method are completed through a post-process and a coating process to solidly stick various patterns on the injection product. The plastic nails are generally coated by using UV coating layer.

However, since the UV coating layer has a property of a very high hardness, there is a problem of chipping that the UV coating and a printed portion of a plastic nail are broken in small pieces because of the impact repeatedly applied to the plastic nail in daily life of a user putting on plastic nails.

In addition, another conventional plastic nails are manufactured by a method of inserting and fixing a film on which some patterns are printed inside the cavity of the injection mold, injecting synthetic resin inside the cavity and hardening the same, and then removing the mold and stripping off the film. Since the patterns printed on the film are transferred to the surface of plastic nails at this moment, the plastic nails get to have various patterns. Such a method for manufacturing plastic nails uses a way of printing patterns on the plastic nails. However, such a method of printing patterns on the surface of plastic nails still has a problem that the printed portions of the plastic nails fall off.

In addition, making patterns through the transfer requires high-level technical skill of transfer, as well as a high-priced transfer printer. Particularly, since such a method of transfer is suitable for an automated mass production, it is difficult to manufacture various kinds of products meeting the customers' various needs in small quantity.

### SUMMARY OF THE INVENTION

Therefore, a method of manufacturing plastic nails having a structure that the printed portion on the fore-end, which is the most vulnerable, does not easily break is required. Particularly, plastic nails having a structure that the printed portion still remains even when the coating layer of the plastic nail falls off are required.

A technical object of the present invention is to provide a method of manufacturing plastic nails having a structure preventing a printed portion and a coated layer of a plastic nail from falling off by the impact in daily life of a user after having put on plastic nails.

Another technical object of the present invention is to provide plastic nails manufactured by a method of manufacturing plastic nails having a structure preventing a printed portion and a coated layer of a plastic nail from falling off by the impact in daily life of a user after having put on plastic nails.

Technical objects of the present invention are not limited to the above-mentioned ones, and other technical objects not mentioned above would clearly be understood by persons of ordinary skill in the art through the following description.

The method of manufacturing plastic nails according to an embodiment of the present invention to achieve the above technical objects comprises printing at least one pattern on a film belonging to the fore-end of the plastic nail, forming the film on which the above-mentioned pattern is printed in the shape of the fore-end of the plastic nail which is curved, cutting the film formed in the shape of the fore-end to make film members, inserting the above-mentioned film members inside the cavities of the injection mold, and forming main bodies of the plastic nails at the same time of integrating the film members with the main bodies of the plastic nails by injecting synthetic resin into the above-mentioned injection mold and hardening the same.

In the above, forming the film on which the pattern is printed in the shape of the fore-end of the plastic nail which is curved and cutting the film formed in the shape of the fore-end to make film members may be performed at the same time using a cutting mold.

The above-mentioned pattern may be formed on the lower surfaces.

The above-mentioned film may be formed of the same material with the above-mentioned synthetic resin.

The above-mentioned film may be formed of transparent or light transmittable material.

Plastic nails according to an embodiment of the present invention to achieve the above-mentioned other technical object may be manufactured by the above-mentioned manufacturing method.

The above-mentioned pattern may be interposed between the film member and the plastic nail member, which are integrated with each other.

The method of manufacturing plastic nails and plastic nails manufactured thereby according to the present invention may prevent the printed portion of the plastic nail or the UV coating layer from falling off and allow various patterns not easily erased to be inserted into the plastic nail.

Besides, it is possible to manufacture customized plastic nails because Using film members respectively corresponding to the fore-end of each plastic nail is more advantageous for small quantity batch production than the way of using roll film.

### BRIEF DESCRIPTION OF THE DRAWINGS

FIG. 1 is a perspective view of a plastic nail according to an embodiment of the present invention.

FIG. 2 is a sectional side view of the plastic nail in FIG. 1.

FIGS. 3 and 4 are views for explaining a method of manufacturing plastic nails according to an embodiment of the present invention.

### DESCRIPTION FOR KEY ELEMENTS IN THE DRAWINGS

10: main body of the plastic nail
11: recess
20: film member
21: pattern
22: connecting member
30: injection mold
31: cavity

### DETAILED DESCRIPTION OF THE PREFERRED EMBODIMENTS

Advantages and features of the present invention and methods to achieve the same will be clear by referring to the attached drawings and the following embodiments described in detail. However, the present invention is not limited to the following described embodiments but can be realized in various forms different from each other. The present embodiments are provided only to make the description of the present invention perfect and to let persons of ordinary skill in the pertinent art perfectly know the scope of the invention and the present invention is defined only by the scope of claims. Like reference numerals denote like parts throughout the specification and drawings.

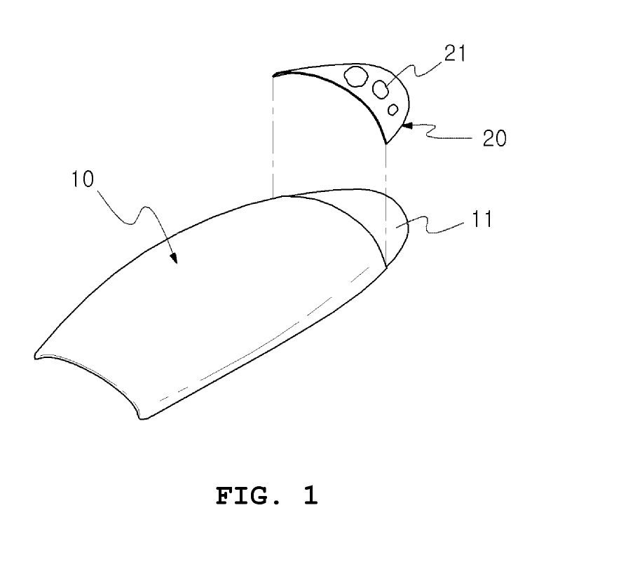

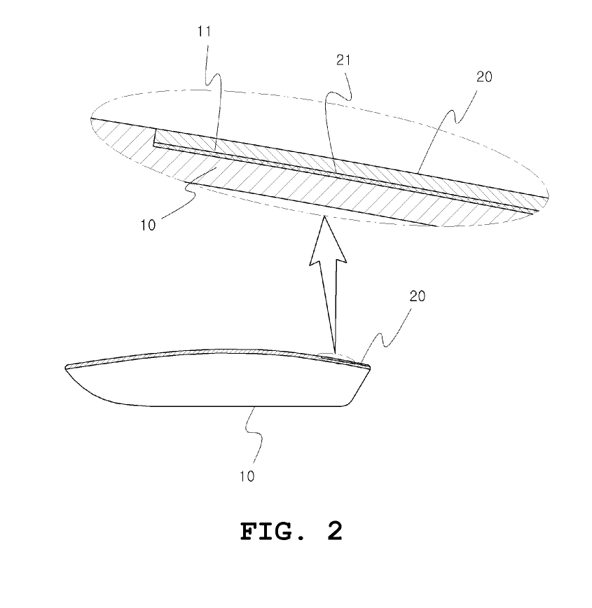

Hereinafter, plastic nails according to an embodiment of the present invention will be described in detail referring to FIGS. 1 and 2.

FIG. 1 is a perspective view of a plastic nail according to an embodiment of the present invention, and FIG. 2 is a sectional side view of the plastic nail in FIG. 1.

The plastic nail according to an embodiment of the present invention comprises a main body 10 of the plastic nail formed by the injection molding with synthetic resin and a film member 20 formed on the fore-end of the main body 10 of the plastic nail.

More specifically, the main body 10 of the plastic nail is formed by injecting synthetic resin having high solidity such as ABS and the same is manufactured by a method of in-mold, that is, by inserting the film member 20 inside the mold and forming by injection. On the fore-end of the main body 10 of the plastic nail, a recess 11 where the film member 20 is inserted is formed.

The recess 11 may be formed on the fore-end forming the upper surface of the main body 10 of the plastic nail. The recess 11 has a depth same as the thickness of the film member 20 and the upper surfaces of the film member 20 and the main body 10 of the plastic nail may practically be even.

Meanwhile, the main body 10 of the plastic nail is formed to have the concave lower surface for allowing the plastic nails to be attached to the real nails. The widths and lengths of the main bodies 10 of the plastic nails are different depending on each nail corresponding to each finger, and the length and the width may vary according to the user's liking. On the film members 20 inserted into the fore-end of the main body 10, various patterns 21 are formed. Such patterns 21 may be formed on the lower surface of the film member 20.

Since the film member 20 may be formed of light transmittable material through which light passes, the patterns 21 formed on the lower surfaces of the film members 20 may be seen from outside of the plastic nails. In addition, the film member 20 may be formed of the same synthetic resin as that of the main body 10 of the plastic nail as necessary. In case that the film member 20 is formed of the same synthetic resin as that of the main body 10 of the plastic nail as mentioned above, it is possible that the boundary between the film member 20 and the recess 11 of the main body 10 are not clearly distinguished.

When the patterns 21 are printed on the lower surfaces of the film members 20, the printed portions having the patterns 21 are positioned between the main bodies 10 of the plastic nails and the film members 20. Here, the patterns 21 are practically combined with the main bodies 10 as well as the film members 20 and they are not exposed to the outside, accordingly, the printed portion having patterns 21 may be prevented from falling off.

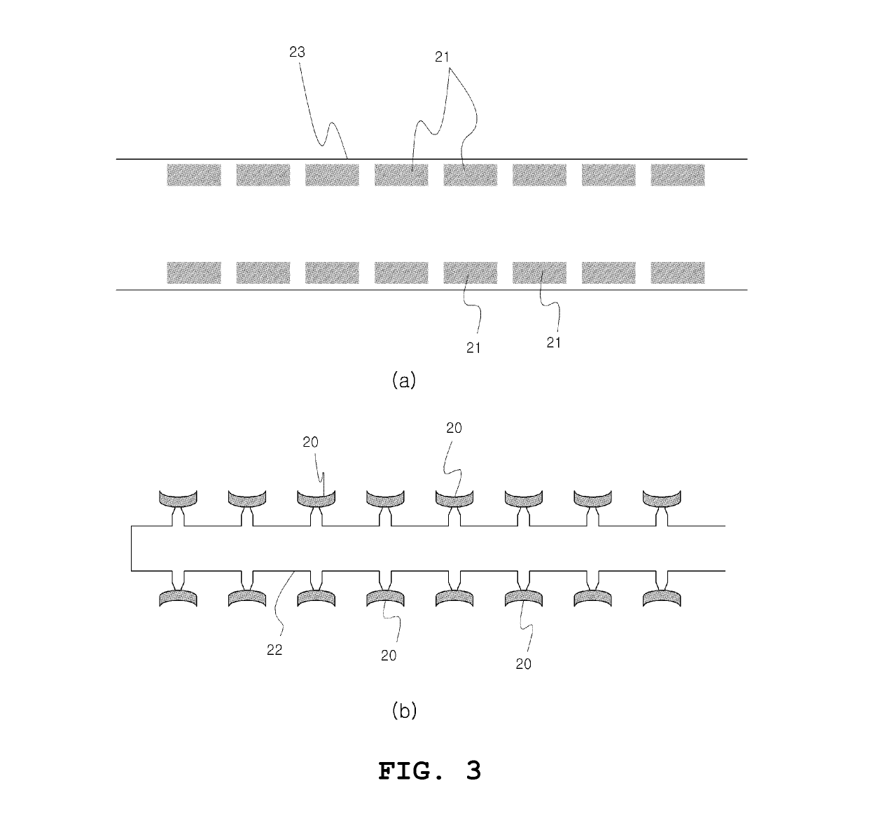

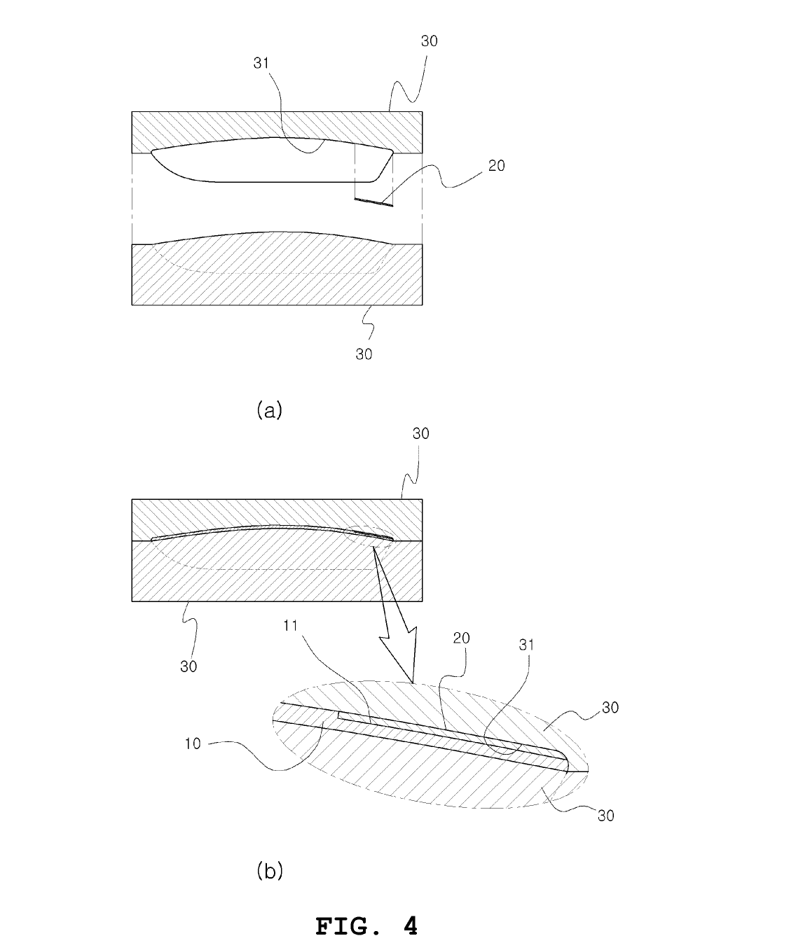

Hereinafter, a method of manufacturing plastic nails will be described in detail referring to FIGS. 3 and 4.

FIGS. 3 and 4 are views for explaining a method of manufacturing plastic nails according to an embodiment of the present invention.

First, referring to FIG. 3(a), the patterns 21 for decoration are printed on the surface of the printing film 23 of a thin synthetic resin.

Here, the patterns 21 are printed on the surface of the printing film 23 through a screen printing machine. As mentioned above, the patterns 21 may be printed on the lower surface of the printing film 23.

On the printing film 23, various patterns 21 may be printed depending on the shape and position of each plastic nail, and the preference. Either one same kind of patterns 21 corresponding to each plastic nail with the same shape and size may be printed on each printing film 23, or various kinds of patterns 21 are printed together on one printing film 23.

Next, referring to FIG. 3(b), film member 20 are manufactured by forming and cutting the printing film 23 on which the patterns 21 are printed.

The printing film 23 with the printed patterns 21 is made of a sheet of a thin synthetic resin such as PC and formed in the shape of fore-end of the plastic nail using a forming machine. That is, the printing film 23 is heated and pressurized by using the forming machine to obtain an upwardly convex shape corresponding to the fore-end of the plastic nail.

After the forming process, the printing film 23 is cut in the shape of each fore-end by using a cutting mold or a cutting machine to form film members 20. Here, the film members 20 respectively for each plastic nail may be manufactured to be connected with each other through a connecting member 22 as shown in FIG. 3(b). Like this, multiple film members 20 may be formed as a unit by connecting with each other through a connecting member 22, and such a unit may comprises the same number of film members as that of plastic nails manufactured at a time. For example, the film members 20 in the shapes of fore-ends, respectively corresponding to each nail of ten fingers may be connected with each other through the connecting member 22, and plastic nails for ten fingers may be manufactured at the same time.

Next, referring to FIG. 4(a), the finished film member 20 is inserted into an injection mold 30. Although FIG. 4 shows that one film member 20 for a fore-end is inserted into one injection mold 30, the film members 20 comprising multiple fore-ends connected with each other through the connecting member 22 as mentioned above may be inserted at the same time.

More specifically, the film member 20 is inserted inside the cavity 31 of the injection mold 30 and fixed there. Particularly, the film members 20 may be inserted into areas corresponding to the fore-ends of the plastic nails inside cavities 31, with being connected with each other through the connecting member 22.

Next, referring to FIG. 4(b), the main body 10 of the plastic nail is formed by injecting synthetic resin such as ABS inside the cavity 31 and hardening the same. When the main body of the plastic nail is manufactured by injecting synthetic resin and hardening the same after having inserted the film member 20 inside the cavity 31 as above, a recess 11 is naturally formed on the upper surface of the fore-end of the main body 10 and the film member 20 is fixed to the upper surface of the recess 11 and integrated with the same.

As mentioned above, the main body 10 of the plastic nail and the film member 20 may be formed of the same synthetic resin. In case that the main body 10 of the plastic nail and the film member 20 are actually formed of the same material, when injecting synthetic resin inside the injection mold 30 after having inserted the film member 30, the main body 10 of the plastic nail and the film member 20 may be integrated. In this case, the film member 20 can solidly be fixed to the main body 10 of the plastic nail.

In addition, since the film members 20 where the patterns 21 are printed are manufactured and the film members 20 are fixed to the fore-ends of the plastic nails and integrated with the same according to the method of manufacturing plastic nails of the present invention, the patterns 21 are very solidly attached to the plastic nails unlike the conventional method of manufacturing plastic nails using transfer. Accordingly, the method of the present invention has an advantage that there is no chipping that the patterns 21, that is, the printed portions fall off by the impact from daily life.

In addition, since there is no need of separate UV coating on the upper surface of the plastic nails, the manufacturing process and the manufacturing system become very simple and the costs may advantageously be reduced. That is, since the patterns are printed on the lower surface of the film member 20, it is possible to produce the product even without separate UV coating. However, there are cases that the UV coating is required depending on the thickness of the film member 20. Even in such cases, since the coating layer is formed on the upper surface of the film member 20 and the printed portion is formed on the lower surface, the printed portion never falls off even when some part of the coating layer falls off.

Particularly, the patterns 21 may be printed on such printing films 23 by using a generally used screen printing machine, there is no need to use a high-priced transfer printing machine, besides, by using such a screen printing machine, various kinds of patterns 21 may be freely printed, so, a small quantity batch production is advantageously possible.

Although an exemplary embodiment that the main body 10 of the plastic nail is formed of ABS is proposed while describing the present invention, the material of the main body 10 of the plastic nail may be varied.

In addition, although proposed is a method of manufacturing film members that the film member 20 is formed by using a forming machine and then cut by using a cutting mold 30 or a cutting machine, cutting the film members 20 before forming the same or the cutting and the forming may be performed at the same time are possible.

Particularly, it is possible to cut the film members 20 to have shapes different from each other depending on the sizes or shapes of the patterns 21 when patterns 21 different from each other are respectively printed on each film member 20.

The above description is only to illustratively describe the technical idea of the present invention, and persons of ordinary skill in the art where the present invention belongs would be able to change and modify the present invention in various ways within the scope of the essential features of the present invention. Therefore, all the above-described embodiments should be understood as examples for explaining the present invention and not limitative in every aspect. The protective scope of the present invention should be interpreted by the following claims, and all the technical ideas within the equivalent scope should be understood to be included in the scope of right of the present invention.

1. A method of manufacturing plastic nails comprising
Printing at least one pattern of the fore-end of the plastic nail on a film;
forming the film on which the pattern is printed in the shape of the fore-end of the plastic nail which is curved;
cutting the film formed in the shape of the fore-end to make film members;
inserting the above-mentioned film members inside the cavities of the injection mold; and
forming main bodies of the plastic nails at the same time of integrating the film members with the main bodies of the plastic nails by injecting synthetic resin into the injection mold and hardening the same.

2. The method of manufacturing plastic nails according to the claim 1, wherein forming the film on which the pattern is printed in the shape of the fore-end of the plastic nail which is curved and cutting the film formed in the shape of the fore-end to make film members are performed at the same time using a cutting mold.

3. The method of manufacturing plastic nails according to the claim 1, wherein the pattern is formed on the lower surface of the film.

4. The method of manufacturing plastic nails according to the claim 3, wherein the film is formed of the same material with the synthetic resin.

5. The method of manufacturing plastic nails according to the claim 3, wherein the film is formed of transparent or light transmittable material.

6. A plastic nail manufactured by a method comprising:
printing at least one pattern located at a fore-end of the plastic nail on a film;
forming the film, on which the pattern is printed, in a shape of the fore-end of the plastic nail which is curved;
cutting the film formed in the shape of the fore-end to make a film member;
inserting the film members into a cavity of an injection mold; and
forming a main body of the plastic nail at the same time of integrating the film member with the main body of the plastic nail by injecting synthetic resin into the injection mold and hardening the same,
wherein the at least one pattern is interposed between the film member and the main body, which are integrated with each other, and
wherein the at least one pattern is formed on a lower surface of the film.

7. The plastic nail according to claim 6, wherein forming the film, on which the pattern is printed, in the shape of the fore-end of the plastic nail which is curved and cutting the film formed in the shape of the fore-end to make the film member are performed at the same time using a cutting mold.

8. (canceled)

9. The plastic nail according to claim 8, wherein the film is formed of the same material with the synthetic resin.

10. The plastic nail according to claim 8, wherein the film is formed of a transparent or light transmittable material.

11-15. (canceled)
